(19) United States
(12) Patent Application Publication
(10) Pub. No.: US 2003/0184092 A1
(43) Pub. Date: Oct. 2, 2003

(54) Flange connection for double-jacket high-pressure pipes

(76) Inventors: Waldemar Hiller, Iserlohn (DE); Josef Hiltawsky, Schwerte (DE); Joerg-Peter Koerner, Hagen (DE)

Correspondence Address: Phillip S Oberlin, Marshall & Melhorn, Four Seagate 8th Floor, Toledo, OH, 43604, US

(21) Appl. No.: 10/362,293

(22) PCT Filed: Sep. 3, 2001
(86) PCT No.: PCT/DE01/03424

(30) Foreign Application Priority Data
Sep. 7, 2000 (DE) 100443362

(51) Int. Cl. F16L 21/02

(52) U.S. Cl. 285/368; 138/109; 285/412

(57) ABSTRACT

The invention relates to a flanged connection for jacketed high-pressure pipes rated for 300 to 10,000 bar, in which the jacket pipe end of at least one of the two jacket-side high-pressure pipe flanged connections is designed as jointed flange, said flange being fixed on the outer side of the high-pressure pipe by means of a jointed connection, said connection being suited to absorb the longitudinal forces in axial direction of the high-pressure pipe and the jointed flange being provided with the bores necessary for the bolts.

The invention relates to a flanged connection for jacketed high-pressure pipes rated for 300 to 10,000 bar. Such jacketed HP pipes are preferably but not exclusively used in the production of the so-called “Low-Density Polyethylene”, hereinafter referred to as LDPE. They consist of two pipes one inserted into each other: the inner pipe conveying the product and the jacket pipe conveying a heat transfer agent. In some applications, this heat transfer agent is used to maintain the temperature in a heat-tracing system, in other cases it serves to increase or lower the temperature of the product conveyed in the inner pipe.

To withstand high pressures and/or temperatures, temperature variations and thermal stresses, it is common practice in high-pressure engineering to use solid and high-tensile materials for pipelines, valves and fittings the processing of which is highly sophisticated, especially if jacket pipes are used. Well-known works standards and manufacturers' brochures on this subject have been published by, inter alia, BASF AG and the applicant, Uhde Hochdrucktechnik GmbH.

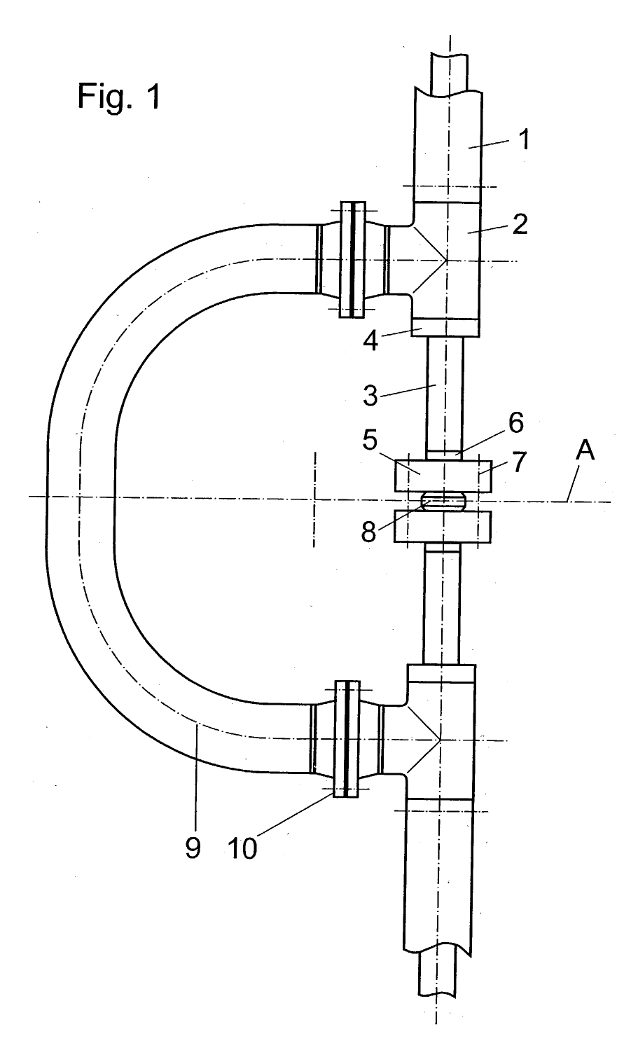

FIG. 1 shows a typical connection of two jacketed high-pressure pipe sections according to this state of the art. The figure is symmetrical to a plane A situated perpendicular to the drawing plane, the pipes shown forming a circular cross-section. Jacket pipe 1 is connected, usually by welding, to nozzle 2. High-pressure pipe 3 penetrates nozzle 2 and is inserted into jacket pipe 1, both pipes jointly forming a jacketed high-pressure pipe assembly. High-pressure pipe 3 is fixed by means of shrunk bush 4 which usually is welded to nozzle 2.

Since it is common practice to use high-tensile low-alloy heat-treatable steel with a relatively high carbon content for the fabrication of high-pressure pipes, for example steel grade 30CroNiMo8 it is impossible to join the inner high-pressure pipe with the components of the jacket pipe by welding. The jacket pipe is therefore fixed by a shrunk connection which at the same time represents a tight, jointed connection that prevents the escape of fluid on the jacket pipe side.

High-pressure pipe 3 is fitted with threaded flange 5 which is screwed onto threaded end 6 of HP pipe 3. Bolts 7 serve to connect threaded flange 5 to its mating component, the tightness of the connection being obtained by the elastic-plastic deformation of the faces of sealing lens 8 and the sealing end faces of high-pressure pipe 3. The elastic-plastic deformation of the said faces is a result of the sealing force transferred by sealing lens 8, the said force being built up when the flanged assembly is pre-stressed by bolts 7.

The jacket-side agent which is used to control the temperature of the liquid transported in the high-pressure pipe is conveyed in a by-pass that consists of pipe bend 9 usually fitted to nozzles 2 by means of flanged connections 10.

Since the sixties the state-of-the-art feature has been that a certain distance is provided between the jacket pipe connection consisting of nozzles 2 and shrunk bushes 4 and the threaded flanges of the jacket pipe consisting of screwed assemblies 5 and threaded ends 6. The distance between shrunk bush 4 and threaded flange 5 is selected to meet fabrication and handling criteria, specifically the space required to tighten bolts 7 mechanically. Such a space requirement constitutes a disadvantage as the pipe ends require sophisticated machining and as this section cannot be exploited for heat exchange in the process.

The aim of this invention therefore is to provide an economical design for the flanged connections, to avoid high-pressure pipe sections which cannot be temperature-controlled, to save constructional space and when applied as double-pipe heat exchanger to improve the efficiency of the latter.

The aim of the invention is achieved by designing the jacket pipe end of at least one of the two jacket-side HP pipe flanged connections as jointed flange, said flange being fixed on the outer side of the high-pressure pipe by means of a jointed connection which is suited to absorb the longitudinal forces in axial direction of the high-pressure pipe as well as the sealing force. The jointed flange is provided with the bores necessary for the bolts.

The jointed connection of the jointed flange described in this invention is preferably provided as shrunk connection but it is also possible to provide the jointed connection as soldered, adhesive or any other type of non-positive locking connection fulfilling the strength requirements, without abandoning the idea of this invention.

The jointed flange according to this invention is preferably made of steel but it is also possible, depending on the respective operating conditions, to use other materials such as titanium, ceramic materials or glass-fibre or carbon-fibre reinforced synthetic materials.

Special advantages will become obvious if not only one but both high-pressure pipe ends are connected with the aid of the jointed flange according to this invention.

According to another embodiment of the invention, at least one end of the high-pressure pipe can be provided with a thread to fit a stop ring. The specialist engineer will especially decide in favour of this option if he intends to additionally secure the shrunk connection by means of a screwed connection as, for example, in the case of longitudinal forces that are acting in axial direction and in a magnitude that would become inadequate on account of the high costs of manufacture.

According to another embodiment of this invention, the jointed flange described in this invention is designed as a split flange, i.e. an internal part consisting of the jointed connection and an external part with bores for the bolts. The connection of the two jointed flange parts is preferably of the non-positive locking type. Such a split jointed flange has the advantage that it is not necessary to ensure exact alignment of the bores for the flange bolts during neither pre-assembly of the counter-flanges nor subsequent jointing.

According to a preferred embodiment of this invention, said non-positive locking connection consists of a circumferential thread/counter-thread connection which is arranged concentrically to the centreline of the high-pressure pipe and in a radial direction between the jointed connection and the pitch diameter of the flange bolts. The thread permits a subsequent alignment of the bores for the bolts by turning the external part of the jointed flange.

A further embodiment of the split jointed flange can be implemented by a simple cone connection, both parts of the jointed flange having conical faces aligned with each other and provided with the same gap angle, the aperture of each cone pointing to the flanged connection and the tip of the cone being located on the centreline of the connected high-pressure pipes. The advantage of such a cone connection is that a self-centring force will act upon the high-pressure pipes when the flange bolts are tightened.

Further embodiments of the split jointed flange are possible without abandoning the basic idea of this invention.

According to another embodiment of this invention, the jacket chamber in the jacket pipe is designed such that the heat transfer agent, which flows from the inlet side of the flanged connection through said chamber extending along the inner high-pressure pipe, must first pass the front face of the jointed flange prior to flowing via a nozzle into a by-pass designed for example as pipe bend.

According to another embodiment of this invention, the jacket chamber in the jacket pipe is designed such that the heat transfer agent, which flows from the outlet side of the flanged connection through said chamber extending along the inner high-pressure pipe, must pass through the by-pass nozzle and then towards the rear face of the jointed flange prior to flowing into the jacket chamber which is located on the nozzle side off the flanged connection.

The two embodiments mentioned last have the advantage that there are no flux-specific dead pockets between the nozzle of the by-pass and the jointed flange, i.e. a section in which the heat transfer might deteriorate.

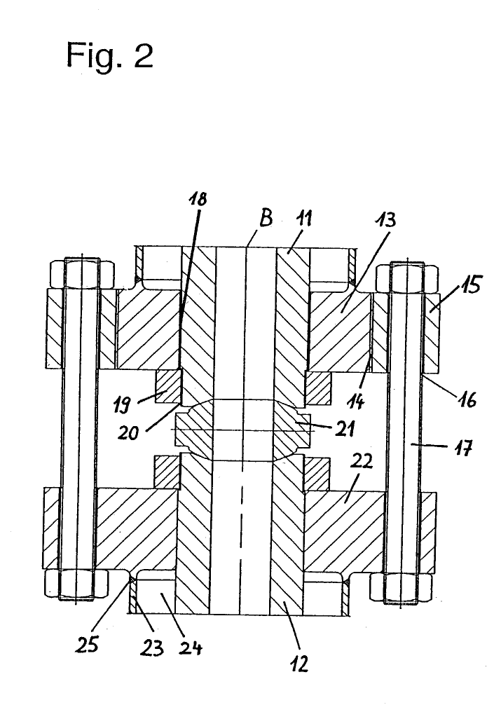

Details of the invention are illustrated by the typical layout drawings shown in FIGS. 2, 3 and 4.

FIG. 2 shows a sectional view of the flanged connection according to this invention,

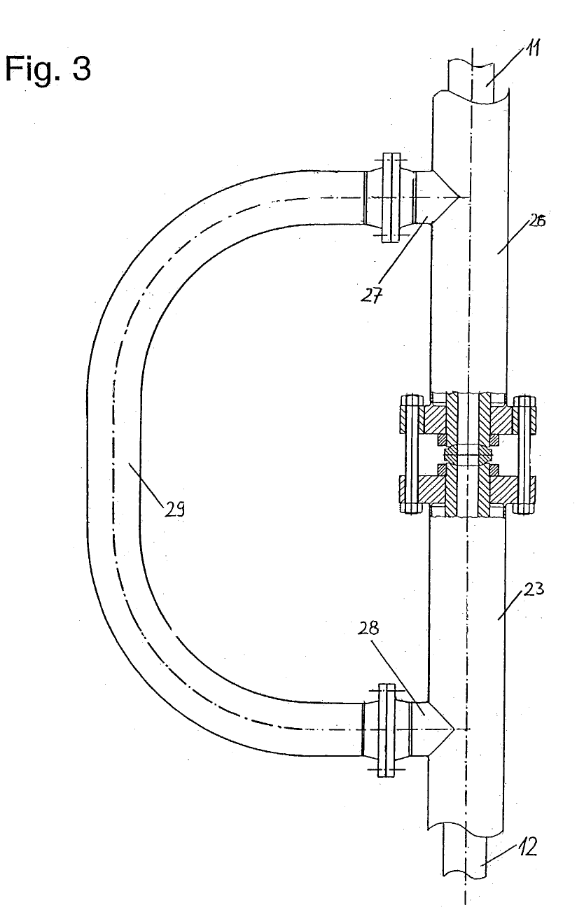

FIG. 3 shows a typical arrangement with jacket-pipe by-pass,

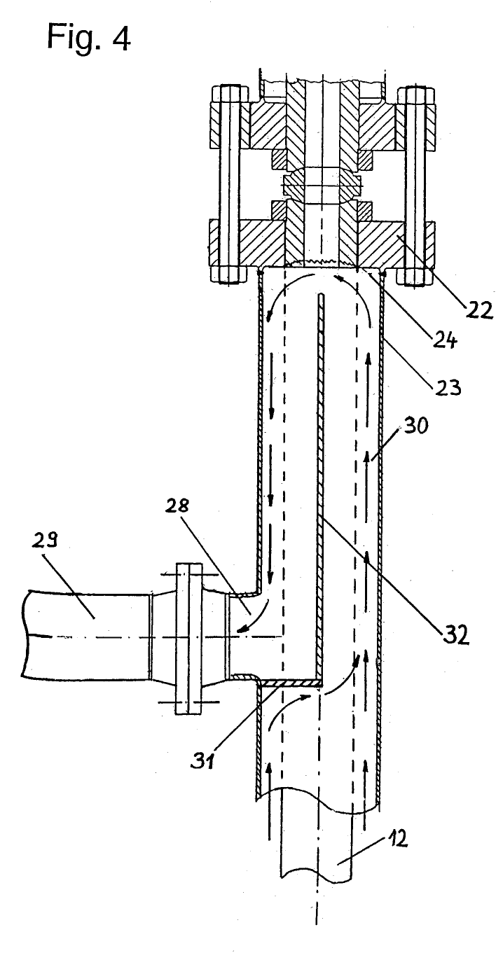

FIG. 4 shows baffles arranged in the areas of nozzle and jointed flange of the jacket chamber.

FIG. 2 shows a flanged assembly consisting of two jointed flanges in accordance with this invention, the upper part showing a split jointed flange and the lower part a monobloc jointed flange. The sectional view shows an axially symmetric arrangement with reference to centreline B, high-pressure pipes 11 and 12 being connected. Internal part 13 of the split jointed flange which consists of internal part 13, thread 14 and external part 15 with bores 16 for bolts 17, is shrunk onto circumferential section 18 of high-pressure pipe 11. The shrunk connection is thus suited to absorb all longitudinal forces acting in axial direction. The split jointed flange is secured by stop ring 19 which is screwed on threaded end 20 of the high-pressure pipe and tightened against internal part 13 of the said flange. The two high-pressure pipes are sealed against the ambience by means of sealing lens 20.

The lower part shown in FIG. 2 depicts jointed flange 22 according to this invention and consists of a monobloc part but it is arranged, fixed and secured analogously to the jointed flange of the upper part shown in the drawing. Both jointed flanges join the associated jacket pipe, i.e. jacket pipe 23 in the case of high-pressure pipe 12, and the associated jacket chamber, in this case chamber 24 located on high-pressure pipe 12. Jointed flange 22 and jacket pipe 23 can, for example, be permanently connected by a welded joint as in the case of joint 25 for jacket pipe 23, and other fixing methods are also feasible in line with this invention.

FIG. 3 shows the flanged assembly depicted in FIG. 2 in conjunction with the two jacket chambers of the two jacketed high-pressure pipes to be connected. Nozzles 27 and 28 are fitted to jacket pipes 23 and 26 and pipe bend 29 is flanged to nozzles 27 and 28. The distance between the two nozzles 27 and 28 is freely selectable but the space required to tighten the bolts mechanically must be taken into consideration. The spacing of nozzles 27 and 28 has in fact a minor impact only on the jacket surface of high-pressure pipes 11 and 12, as the jacket chamber extends as far as the associated jointed flange irrespective of the nozzle-to-nozzle spacing which is an advantage of the invention.

FIG. 4 shows a typical arrangement of baffles which provides for a stream pattern in the jacket chamber located in the jacket pipe so that the heat transfer agent which flows from the inlet side of the flanged connection through the said chamber extending along the inner high-pressure pipe is forced to pass first the front face of the jointed flange prior to flowing via a nozzle into a by-pass pipe bend. The layout drawing shows a section of jacket pipe 23; in this example it is assumed that baffle 31 prevents heat-transfer agent stream 30, which flows in the direction shown by arrows and which enters jacket chamber 23 from the bottom part shown in the sectional view, from forming a straight forward stream into nozzle 28 and from there into pipe bend 29, also refer to FIG. 3. Baffle 31 may, for example, be shaped as a semi-circle of a ring disk, the outside diameter being equal to the inside diameter of the jacket pipe and the inside diameter being equal to the outside diameter of the inner high-pressure pipe. But it is also possible to select a different form obstructing one half of the jacket chamber which will better suit the lines of the flow pattern. Baffle 32 provides a longitudinal partition of jacket chamber 24 almost up to jointed flange 22 where the flow direction of heat-transfer agent stream 30 is reversed. Baffle 32 consists of two parts; i.e. analogously to the represented sectional view, an equivalent baffle 32 is arranged on the opposite side of the high-pressure pipe.

Baffles 31 and 32 may also be formed as a single plate without abandoning the idea of this invention. This also applies to the option of providing the baffles on the other side of the flanged connection.

Further merits provided by this invention are the cost-effective manufacture of the flanged connections of pipe bend components and the reduction of the total number of components required.

List of References Used:

a) Present state of the art:

1 Jacket pipe

2 Nozzle

3 High-pressure pipe

4 Shrunk bush

5 Threaded flange

6 Threaded end

7 Flange bolts

8 Sealing lens

9 Pipe bend

10 Flanged connection

b) Invention

11 High-pressure pipe

12 High-pressure pipe

13 Internal part

14 Thread

15 External part

16 Bores

17 Flange bolts

18 Circumferential section

19 Stop ring

20 Threaded end

21 Sealing lens

22 Jointed flange

23 Jacket pipe

24 Jacket chamber

25 Welded joint

26 Jacket pipe

27 Nozzle

28 Nozzle

29 Pipe bend

30 Heat-transfer agent stream

31 Baffle

32 Baffle

1. Flanged connection for jacketed high-pressure pipes rated for 300 to 10,000 bar, characterised in that
a) the jacket pipe end of at least one of the two jacket-side high-pressure pipe flanged connections is provided as jointed flange,
b) this jointed flange is fixed on the outer side of the high-pressure pipe by means of a jointed connection,
c) the said jointed connection is suited to absorb the longitudinal forces in axial direction of the high-pressure pipe,
d) the jointed flange is provided with the bores necessary for the bolts.

2. Assembly according to claim 1, characterised in that the jointed connection of the jointed flange according to this invention is provided as shrunk connection.

3. Assembly according to claim 1, characterised in that the jointed connection of the jointed flange according to this invention is provided as soldered connection.

4. Assembly according to claim 1, characterised in that the jointed connection of the jointed flange according to this invention is provided as adhesive connection.

5. Assembly according to one of the claims 1 to 4, characterised in that the jointed flange according to this invention is made of steel.

6. Assembly according to one of the claims 1 to 4, characterised in that the jointed flange according to this invention is made of titanium.

7. Assembly according to one of the claims 1 to 4, characterised in that the jointed flange according to this invention is made of ceramic material.

8. Assembly according to one of the claims 1 to 4, characterised in that the jointed flange according to this invention is made of synthetic material reinforced with carbon and/or glass fibres.

9. Assembly according to one of the claims 1 to 8, characterised in that both high-pressure pipe ends to be connected to each other are connected with the aid of jointed flanges according to this invention.

10. Assembly according to one of the claims 1 to 9, characterised in that at least one end of the high-pressure pipes to be connected is provided with a thread to fit a stop ring.

11. Assembly according to one of the claims 1 to 9, characterised in that a jointed flange according to this invention is provided as a split flange, i.e. an internal part consisting of the jointed connection and an external part with bores for the bolts.

12. Assembly according to claim 11, characterised in that the connection of the two jointed flange parts is of the non-positive locking type.

13. Assembly according to claim 12, characterised in that this non-positive locking connection of the two jointed flange parts consists of a circumferential thread-counterthread connection which is arranged concentrically to the centreline of the high-pressure pipe and in radial direction between the jointed connection and the pitch diameter of the flange bolts. The thread permits a subsequent alignment of the bores for the bolts by turning the external part of the jointed flange.

14. Assembly according to claim 11, characterised in that the two jointed flange parts are connected by a simple cone connection, both parts of the jointed flange having conical faces aligned with each other and provided with the same gap angle, the aperture of each cone pointing to the flanged connection and the tip of the cone being located on the centreline of the connected high-pressure pipes.

15. Assembly according to one of the claims 1 to 14, characterised in that the jacket chamber in the jacket pipe is designed such that the heat transfer agent, which flows from the inlet side of the flanged connection through said chamber extending along the inner high-pressure pipe, must first pass the face of the jointed flange prior to flowing via a nozzle into the by-pass.

16. Assembly according to one of the claims 1 to 15, characterised in that the jacket chamber in the jacket pipe is designed such that the heat transfer agent, which flows from the outlet side of the flanged connection through said chamber extending along the inner high-pressure pipe, must pass through the by-pass nozzle and then towards the rear face of the jointed flange prior to flowing into the jacket chamber which is located on the nozzle side off the flanged connection.

17. Process according to one of the claims 1 to 16, characterised in that the flanged connection according to this invention is suited for and used in the production of LDPE.
